(19) United States
(12) Patent Application Publication
(10) Pub. No.: US 2008/0110930 A1
(43) Pub. Date: May 15, 2008

(54) Mixing Head for Multiple Components Systems and UsesThereof

(75) Inventors: Joel Wittkamp, Morrisville, NC (US); James R. Gentry, Jr., Morrisville, NC (US); Albert J. Scott, Wyncote, PA (US)

Correspondence Address: VENABLE LLP, P.O. BOX 34385, WASHINGTON, DC, 20043-9998, US

(73) Assignee: MIXTEK SYSTEM, LLC, NEW YORK, NY (US)

(21) Appl. No.: 10/585,110

(22) PCT Filed: Dec. 30, 2004
(86) PCT No.: PCT/US04/43812

§ 371 Date: Oct. 16, 2007

Related U.S. Application Data
(60) Provisional application No. 60/533,611, filed on Dec. 31, 2003.
(60) Provisional application No. 60/537,535, filed on Jan. 21, 2004.

(51) Int. Cl. B67D 5/52; B67D 5/60; A47G 19/12; B65D 83/00

(52) U.S. Cl. 222/135; 222/145.6; 222/472; 222/402.15

(57) ABSTRACT

A mixing device for use atop a plurality of containers that contain constituents that are to be mixed and dispensed is described. The device includes a head having an outlet and a cartridge that has inlets for accepting constituents from each of the plurality of containers, a mixing chamber, and a nozzle for dispensing a mixed product extending through the opening in the head. The device includes a means for securing the head to the containers. A mixing system can include the device together with the containers holding the constituents to be mixed.

This application claims the benefit of U.S. Provisional Patent Application No. 60/533,611, filed Dec. 31, 2003 and U.S. Provisional Patent Application No. 60/537,535, filed Jan. 21, 2004, each of which is incorporated herein by reference in its entirety.

### BACKGROUND

1. Field of the Invention

This invention relates to dispensers for multi-constituent products. More particularly, the invention relates to a device that can be attached to multiple containers for accepting, combining and mixing constituents from the containers, and dispensing a mixed product.

2. Background of the Invention

It has long been known to dispense a single-component fluid product under pressure from an aerosol or pump-type container or the like. Dispenser structures are also known which are formed on, or mountable to, a single pressurized dispensing container. Known single-canister nozzle assemblies include the stem and actuator assemblies commonly used on spray paint cans and hair spray cans, as well as the flexible stem assemblies commonly used on whipped cream cans. Such nozzle assemblies are adequate for dispensing a single chemical product contained in a single pressurized canister. Other dispensers are used to convert a stream of a dispensed product into a form more useable for a given application. In the hair care field, for example, one type of known applicator consists of an appliance having a comb or brush type structure mountable on a pressurized dispensing container. This type of device has internal conveying means for conveying a hair treatment fluid from a nozzle of the pressurized dispensing container to one or more outlet ports to enable the direct application of the hair treatment fluid to the user's hair. This type of device has been made available for use with products such as shampoo, conditioner, styling formula, and hair dye to enable one-hand use and easy manipulation by a consumer or stylist.

Various types of dispensers are also known which are capable of dispensing a multi-constituent product by means of the ejection and mixing of two different, fluid constituents from separate containers. For example, U.S. Pat. No. 4,773,562 discloses a dispenser of the latter type, which is used for dispensing a two-constituent self-heating shaving cream comprising a first constituent including a reducing agent and a second constituent including an oxidizing agent reactive with the reducing agent to liberate heat.

Dispensing devices that provide for the simultaneous release of materials from two containers in response to the pressing of a valve release button or actuation of a pump generally include tubes, ducts, or similar structure for conveying each of the two materials from the respective containers to a chamber at which the materials are combined, the chamber having a single outlet port or nozzle at which the material is dispensed. In U.S. Pat. No. 4,773,562, for example, a dispensing head is provided-with a Y-shaped groove having lateral arms for separately conveying materials dispensed from two different containers to a median arm, where the two materials are conveyed as a combined product to a single outlet nozzle.

In fluid application processes requiring the use of a multi-constituent product that must be mixed immediately before application to a given object, few known devices are capable of dispensing, mixing and applying such products in a satisfactory manner. For example, in the use of multi-component hair dye products, the user or stylist is generally required to carefully perform a number of manual operations to properly mix the individual components before applying the mixture to the hair. Epoxy adhesives, exothermic shaving creams, tooth whitening formulations, and some cleaning compounds, for example spot carpet cleaners, are further examples of multi-constituent products that must be mixed immediately before use.

Existing systems for dispensing, mixing and applying multi-constituent mixtures that are mixed prior to use generally involve either (a) numerous components or (b) a large mixing system which may be difficult and/or expensive to manufacture. There is a continuing need for simple devices that can be produced economically in order to satisfy the various markets for mixed products.

There exists an unmet need for a nozzle assembly that permits simultaneous dispensing of pressurized constituents from multiple pressurized canisters. For example, where a chemical reaction is desired after dispensing, providing separate canisters having a common nozzle for mixing and dispensing would be desirable. For example, to dispense, mix, and spray an adhesive base and a chemical activator to activate the adhesive properties of the adhesive base, it would be desirable to provide the adhesive base in one pressurized canister and the activator in a separate pressurized canister, and to mix the two products and expel the homogeneous mixture as a spray onto the surface to be bonded. Other applications of chemical products that would benefit from dispensing and mixing through a common nozzle assembly include exothermic applications, where mixing two chemicals would yield a heated dispensed chemical composition. The unsolved challenges that have prohibited successful implementation of such dual-canister applications, especially in the consumer products market, is the requirement for controlled dispensing of a known quantity of each chemical, the requirement of truly homogeneous mixing prior to expelling the mixed chemical composition through the nozzle outlet.

### SUMMARY OF THE INVENTION

A mixing device is described that includes a head having an outlet and adapted for holding a cartridge atop a plurality of containers, for example two containers; a cartridge with an inlet for accepting constituents from each of the plurality of containers, a mixing chamber, and a nozzle for dispensing a mixed product extending from the cartridge through the opening in the head; and means for securing the head to the containers. The device can also be used for a larger number of containers, for example, three, four or more containers. The interior walls of each inlet can have a conical configuration. The means for securing the head to the containers can be integral with the head or can be a separate component that is attachable to the head and the containers. The mixing chamber can include columns, baffles, or other means for creating a turbulent flow of materials. The nozzle can include a valve insert, such as a mechanical breakup valve.

The device can include various mechanisms for depression of the cartridge and outletting of the canister constituents. For example, there can be a hole in the head for depression of the cartridge or a trigger, that can be a lever, for depression the cartridge.

The invention is also a mixing system that includes the device together with the plurality of containers. The canisters can each include an aqueous solution, such as an acid and a basic solution. The system can include means for securing the canisters together, for example, a structure in the head, such as a collar, or a structure separate from the head, such as shrink wrap and/or a separate collar attachable to the head and the canisters.

The present apparatus is provided for simultaneously dispensing constituents such as chemical compositions from at least two pressurized canisters. The apparatus includes a head adapted for receiving a cartridge and further adapted for receiving at least two pressurized canisters, the head can also have a handle; a lever having a first end pivotally attached to the head, and a second opposite end adjacent the handle. The lever can include a protruding tab between the two ends of the lever disposed to exert pressure on the cartridge when the lever is activated by a user pressing down on the second opposite end. The cartridge has an internal passageway adapted for communicable connection to the at least two pressurized canisters, the internal passageway including a central passage portion forming a mixing chamber having at least one mixing baffle.

The cartridge provides for controlled dispensing of a known quantity of each chemical provided in a separate pressurized canister, and provides a homogeneous mixing in the mixing chamber within the apparatus prior to expelling the mixed chemical composition through the nozzle outlet.

Another advantage of the apparatus of the present invention is that it provides for single-handed operation without any compromise in quality of the homogeneously mixed and dispensed chemical product.

Further objectives and advantages, as well as the structure and function of preferred embodiments will become apparent from a consideration of the description, drawings, and examples.

### BRIEF DESCRIPTION OF THE FIGURES

The foregoing and other features and advantages of the invention will be apparent from the following, more particular description of a preferred embodiment of the invention, as illustrated in the accompanying drawings wherein like reference numbers generally indicate identical, functionally similar, and/or structurally similar elements.

FIGS. 1A and 1B are front and rear perspective views of an embodiment of the device mounted atop a pair of canisters.

FIG. 2 is a bottom view of an embodiment of the device.

FIG. 3 is a front view of the head of the device according to an embodiment of the invention.

FIG. 4 is a side view of the head of the device according to one embodiment of the invention.

FIG. 5 is a bottom view of the device according to the invention with the cartridge removed.

FIG. 6 is a perspective view of a lever for use with the present invention.

FIG. 7 is a bottom view of an embodiment of a cartridge for use in the preset invention.

FIG. 8 is a top view of the head according to an embodiment of the invention.

FIGS. 9A and 9B are top views of the cartridge according to embodiments of the invention.

FIG. 10 is a bottom view of the cartridge according to an embodiment of the invention.

FIG. 11 is an exploded view of the cartridge according to an embodiment of the invention.

FIGS. 12A and 12B are internal views of the bottom portion and top portion, respectively, of a cartridge according to an exemplary embodiment of the invention.

FIGS. 13A and 13B are top views of alternative bottom portions of a cartridge illustrating alternative baffle arrangements.

### DETAILED DESCRIPTION

Embodiments of the invention are discussed in detail below. In describing embodiments, specific terminology is employed for the sake of clarity. However, the invention is not intended to be limited to the specific terminology so selected. All references cited herein are incorporated by reference as if each had been individually incorporated. While specific exemplary embodiments are discussed, it should be understood that this is done for illustration purposes only. A person skilled in the relevant art will recognize that other components and configurations can be used without parting from the spirit and scope of the invention.

The present invention includes further embodiments of the invention disclosed in commonly owned International Application No. PCT/US03/22282, the specification of which is specifically incorporated herein by reference in its entirety.

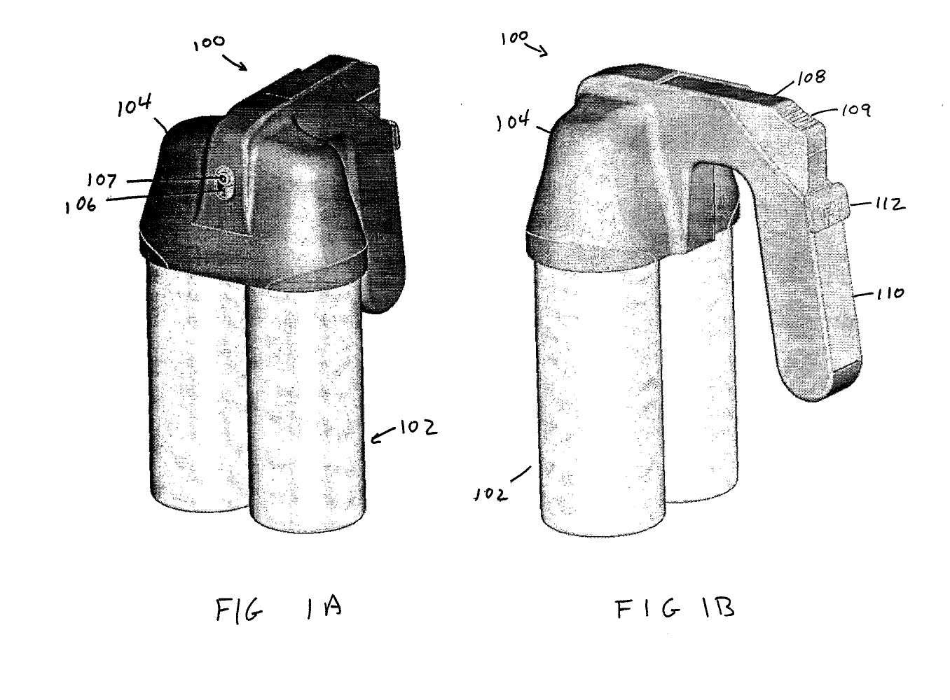

FIG. 1A shows the front perspective view of a mixing device 100 according to the present invention attached to the top of a pair of canisters 102. The device 100 includes the head 104 having an opening 106. A nozzle 107, which is attached to internal components of the mixing device 100 described further below, is positioned within the opening 106 so that the mixed product, when dispersed, can exit the mixing device 100. FIG. 1B is a rear perspective view of the mixing device 100 attached to canisters 102. The mixing head 104 includes a handle 110 integrally attached thereto. In other embodiments of the present invention, there is no handle. The handle 110 is particularly useful when the canisters 102, when paired side by side, are too large for grasping with one hand.

Extending from the interior of the head 104 to the exterior in the depicted embodiment is a lever 108. The lever 108 can include a thumb trigger 109 which, when depressed, actuates release of constituents from the canisters 102. The pictured embodiment also includes a tamper-resistant tab 112 that prevents inadvertent depression of the lever 108 so that the contents of the canisters 102 are not released before desired. As will be appreciated, when used, depression of the thumb trigger 109 and, concomitantly, the lever 108, creates pressure at the junction of the lever with the tamper-resistant tab 112 so that the tab breaks away and the device can be used.

FIG. 2 is a bottom view of the mixing device 100 according to the present invention with the canisters removed. As can be seen, the interior of the mixing device 100 includes a cartridge 202 which is described in more detail below. As shown in FIG. 2, the lever 108 can extend into the interior of the mixing device 100 for depression of the cartridge 202 and release of the constituents in the containers. The cartridge 202 includes inlets 204 through which the constituents of the containers 102 enter the cartridge 202.

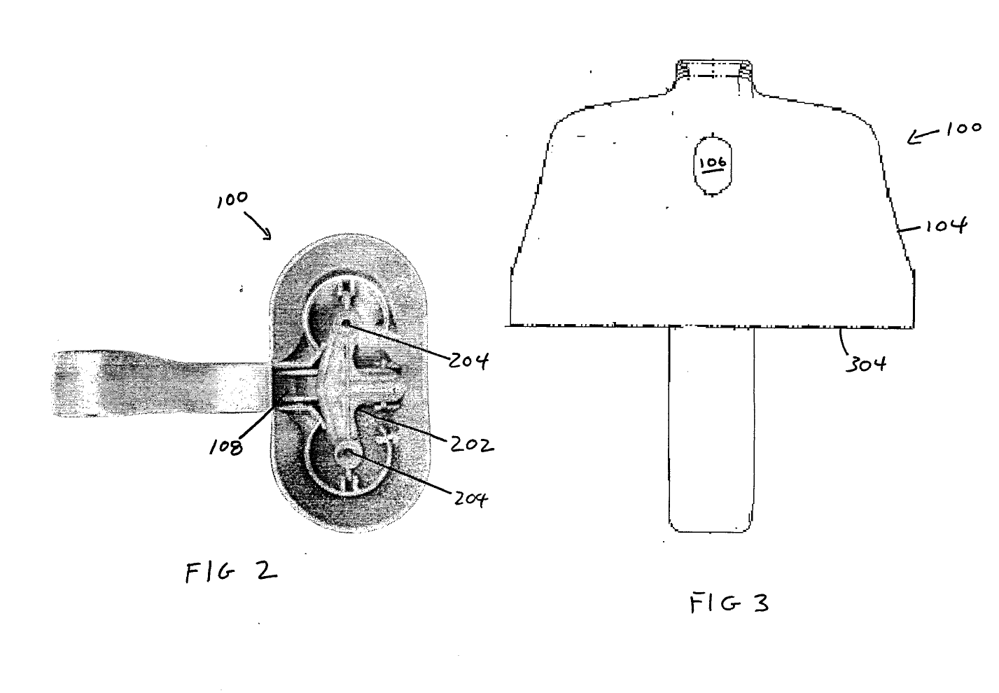

FIG. 3 is a front view of the head 104 of the mixing device 100 that depicts the opening 106 through which the mixed canister contents are dispensed. The base of the head 104 forms a collar 304 for attachment to the canisters 102. The collar 304 at the base of the head 104 is sized such that, when the device 100 is placed on top of the canisters 102, the collar holds the head on the canisters. This can be accomplished through, for example, a simple friction fit, or by having tabs or a ridge present around the base of the collar on its interior surface which further hold the head on the canisters. FIG. 4 is a side view of the head 104 according to an embodiment of the invention further showing the handle 110 and collar 304.

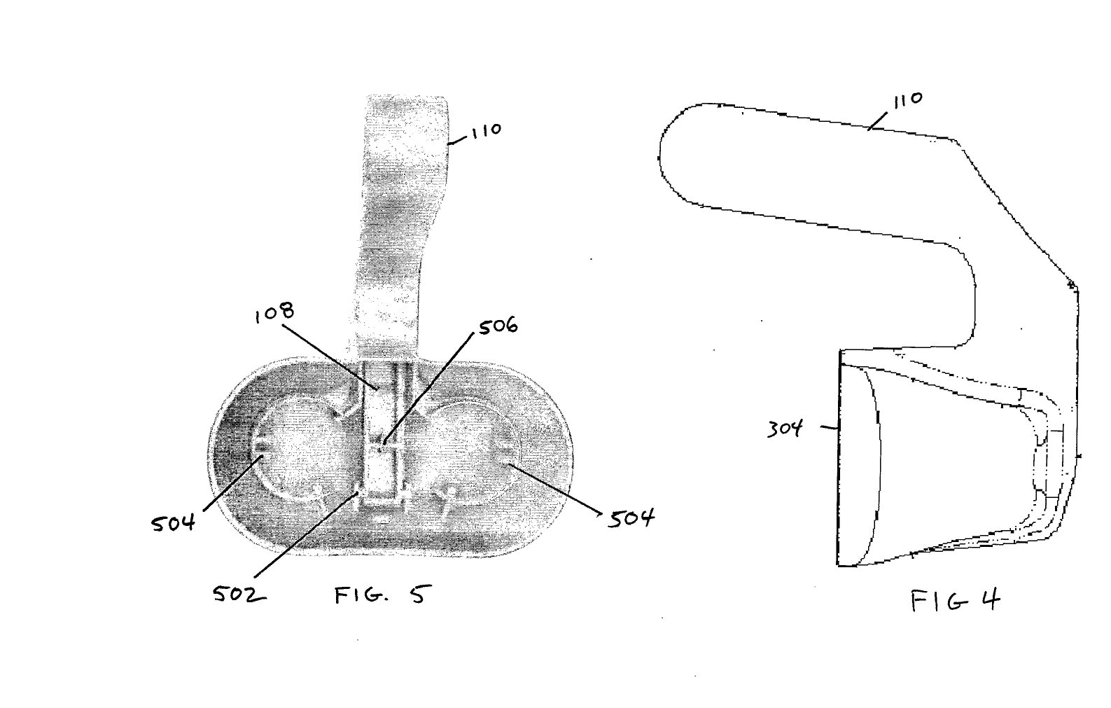

FIG. 5 is a bottom view of the head 104 according to the invention with the cartridge 202 removed therefrom. Inside the head are guides 504 which engage guide pins on the cartridge (see FIG. 7) to assure a regular up and down motion of the cartridge within the head. With the cartridge removed, the lever 108 and an exemplary mechanism for its attachment to the head 104 is visible. In this exemplary embodiment, the lever 108 is attached by a pivot axle 502 to a tabbed portion inside the head to form a hinge.

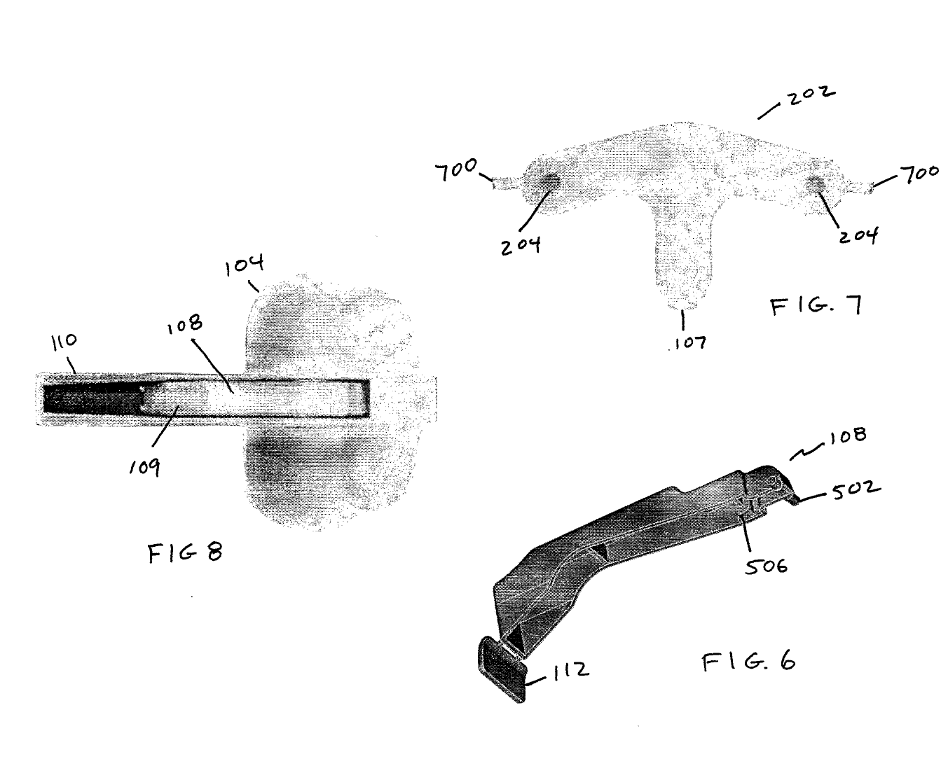

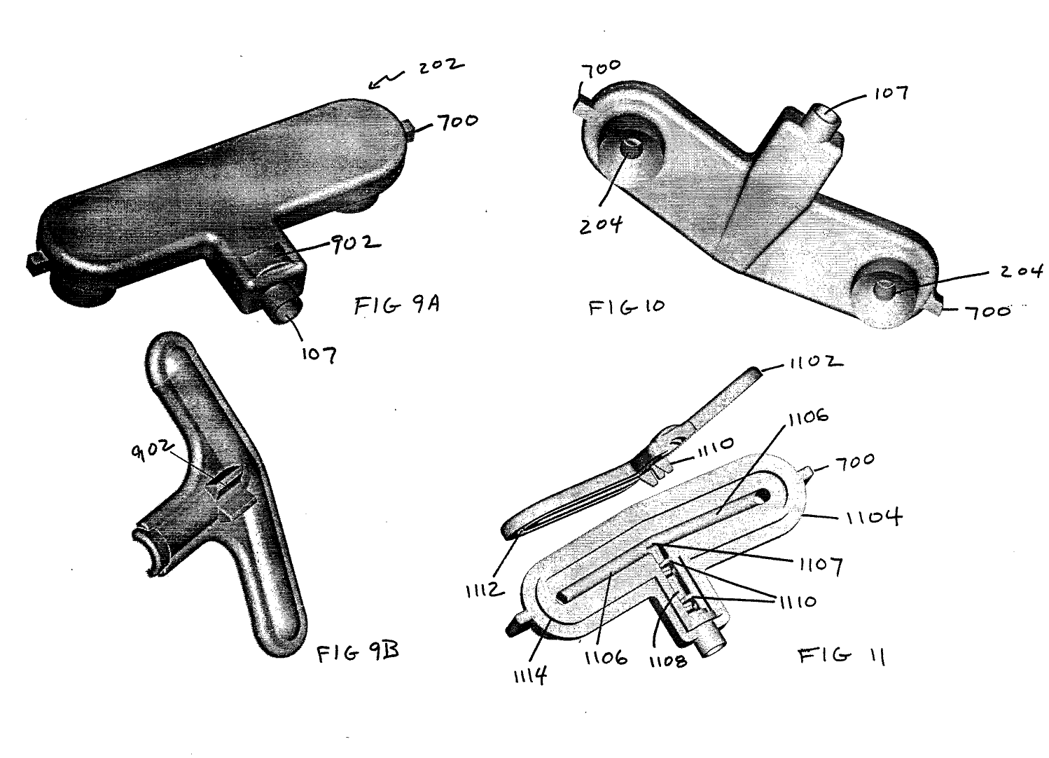

As shown in FIG. 6, lever 108 thus includes a first end that includes a pivot axle 502 that is pivotally attached to the interior of the head 104, and a second opposite end adjacent the handle portion. A pressure point, such as a protruding tab 506, is provided between the two ends of the lever, preferably adjacent the first end. The protruding tab is disposed so as to exert pressure on the cartridge 202 when the lever is activated by a user pressing down on the second opposite end, for example at the thumb trigger 109. The cartridge 202 can have a pressure receiving block 902 (see also FIG. 9) for receiving the protruding tab 506 for consistent distribution of pressure applied to the nozzle body through activation of the lever. The second opposite end of the lever can contain a safety mechanism, such as a break-away safety tab 112 that prevents activation of the trigger until the safety is removed or otherwise deactivated by a user.

FIG. 7 shows the cartridge 202 removed from the head 104. The cartridge includes inlets 204 through which constituents from the containers 102 are released. When the constituents of the containers are released into the inlets 204, they travel through an internal channel within the cartridge 202 to a mixing chamber (described below), and exit through the nozzle 107. The guide pins 700 are present at the edges of the cartridge. The guide pins 700 are engaged with the guides 504 when the cartridge is inserted into the head 104, to maintain the proper alignment of the cartridge with the container stems when force is applied to the cartridge through the lever. Such means maintain the perpendicularity of the cartridge with respect to the container stem so as to create an effective seal between the inlets and the container stem to the internal passageway of the cartridge. The cartridge 102 is positioned within the head 104 so as to float, or be substantially unencumbered from lateral and vertical movement within the head so as to easily and automatically align itself to engage the pressurized container stems.

FIG. 8 is a top view of the head 104 of the mixing device 100. The lever 108 exits the head 104 through a channel in the handle 110. In FIG. 8, the tamper resistant tab 112 has been removed from the lever 108 through use.

FIG. 9A is a top perspective view of an exemplary embodiment of the cartridge 202 used in the mixing device 100 of the present invention. In this embodiment, the top surface of the cartridge 202 is relatively flat, but includes a receiving block 902 for receiving pressure from the protruding tab at the lever. FIG. 9B illustrates another exemplary embodiment of the top portion of the cartridge wherein the pressure receiving block 902 is in the form of a v-shaped block to receive pressure from the protruding tab of the lever. The presence of a receiving block 902 helps insure that the force applied by the protruding tab is balanced between the multiple containers, affecting an equal dispensing of the chemical components into the nozzle body internal passageways.

Guide pins 700 extend laterally from the cartridge 202. The nozzle 107 of the cartridge 202 is positioned perpendicular to an imaginary line extending between the guide pins 700 of the cartridge. This particular arrangement of the nozzle is not critical; the nozzle may be located in different areas of the cartridge 202. The cartridge 202 can have a nozzle insert placed within the nozzle 107. The nozzle insert can be one of several different configurations including a straight narrow channel or the channel can include baffles or other obstructions. Nozzle inserts are known in the art and are commercially available. Baffles or other obstructions in the nozzle insert can create turbulence in the product stream in order to enhance further mixing. In addition, the nozzle insert can disrupt or break up the flow of the product stream, which may or may not include propellant, in order to reduce droplet size when the product is dispensed and thus modify the physical nature of the mixed product exiting the device. The exact nozzle insert used will depend upon the end use and, for example, whether the mixed product is to be dispensed as a stream or as a spray. Alternatively, the opening of the nozzle 107 may be of a smaller diameter for release of a narrow stream of mixed product.

FIG. 10 is a bottom view of the cartridge 202. In canisters having a straight tube exiting from the top, as are well known in the art, it is important that the tube seat securely within the inlet 204 and that there is no leakage of material as it exits the canisters and enters the cartridge. The inlet 204 can have a conical shape of the interior wall being more narrow towards the cartridge and the opening of the inlet 204 broadening as one moves away from the cartridge to ensure firm seating of the tubes. This arrangement facilitates a secure seating of the tubes exiting from containers 102 without the use of O-rings. The use of O-rings would involve additional manufacturing steps requiring a precise placement and thus add to manufacturing costs. Therefore, the conical arrangement is particularly advantageous. Alternatively, the inlets may be configured with protruding stem portions to permit communicable connection to stemless canisters.

As illustrated in FIG. 11, the cartridge 202 can be composed of two portions which can be separately formed, for example by injection molding, and then joined to form a complete cartridge. Such a cartridge includes a top portion 1102 and a bottom portion 1104. The interior of the cartridge 202 includes a channel 1106. As will be appreciated by persons skilled in the art, the channel 1106 in the bottom 1104 can mate with a complementary channel 1116 in the top 1102 to form a substantially tubular passageway for flow of constituents. Canister constituents entering each of the inlets 204 travel through the channel to a confluence 1107. The channels from the inlets to the confluence 1107 and the mixing chamber passageway from the confluence 1107 to the nozzle 107 define a “T” shaped structure. After the two streams from the separate inlets 204 are combined, the combined constituents enter a mixing chamber 1108. The top portion 1102 and bottom portion 1104 can include a joining surface containing means for joining two portions together, shown as a recessed, grooved, slot 1112 around the periphery of the joining surface of the top portion that mates with a corresponding protruding tab portion 1114 provided around the periphery joining surface of the bottom portion. The joining surfaces can be permanently adhered by any known means, but are preferably joined by adhesives or by sonic welding.

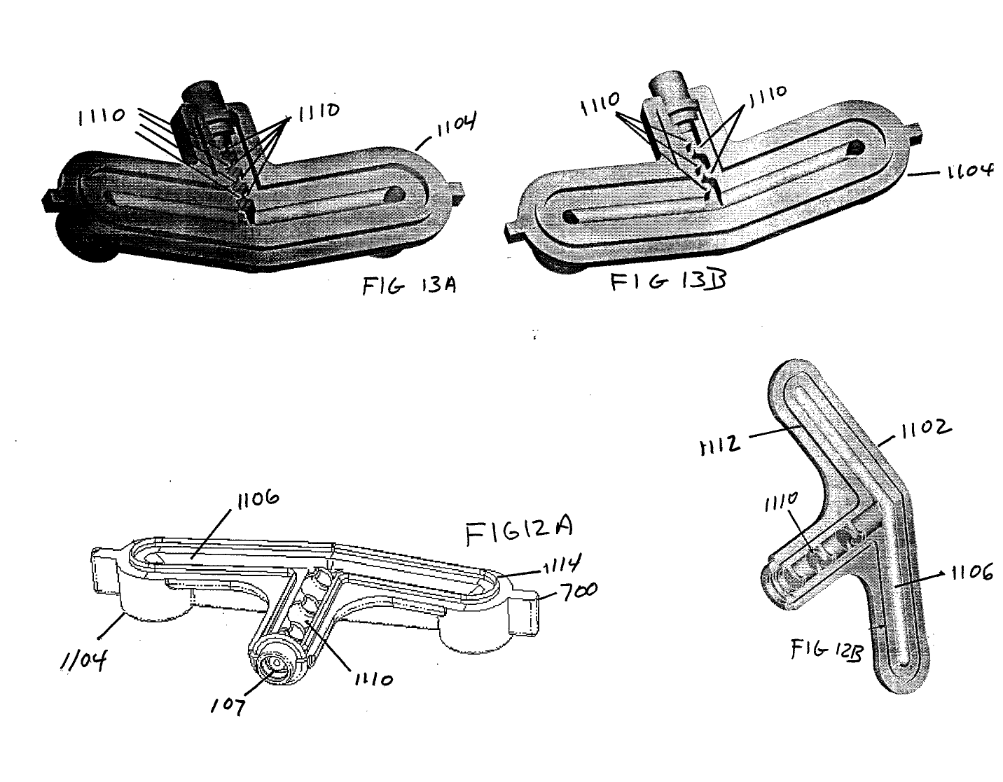

The mixing chamber 1108 can include baffles 1110, as depicted in the embodiment of FIG. 11, which create turbulent flow contents within the mixing chamber 1108 so that the combined constituents from the separate canisters become thoroughly mixed before exiting through the nozzle 107. The top portion 110, contains mixing components within a channel that, together with the bottom portion 1104, define the mixing chamber. FIGS. 12A and 12B illustrate bottom portion 1104 and top portion 1102, respectively, of a cartridge with an alternative baffle arrangement. In this embodiment, the baffles 1110 are disc-shaped baffles disposed in the mixing chamber, with a crescent shaped orifice forming an opening between the periphery of the disc baffle 1110 and the wall of the passageway of the mixing chamber. The crescent-shaped disc baffles can be arranged in series pairs or sets, with the discs in each pair or set rotatably disposed so as to offset the orifice opening of each disc baffle relative to the orifice opening in the next disc baffle in the series. In this particular embodiment, offsetting the orifice openings of disc baffles creates a spiral flow of constituents through the central passage portion. In addition, the shape of the orifice opening contracts the flow stream as it passes through the baffle. Once the flow stream exits the baffle orifice, it expands into the space available between baffles. Since the orifice openings are offset or rotated with respect to one another, the flow stream is forced to make a sharp, preferably 90°, turn and then to expand into the full volume of space in the adjacent cylindrical central passage area. As the flow passes through the next baffle set, it is once again forced to make another hard, preferably 90°, turn, and expand to fill the next cylindrical central passage area on the opposite side of the baffle set. This process is continued throughout the length of the central passageway until the flow reaches the nozzle end. This combination of alternating contraction into the orifice openings and expansions into the space between baffles creates a significant turbulence in the flow stream thereby creating an effective mixing of the two or more chemical components. At least two sets of four baffles can be provided within the mixing chamber with the orifice openings in each set of baffle discs offset from each other, so as to create spiral flow that alternately increasing and decreasing in velocity producing abundant turbulence in the flow stream causing effective mixing of the chemical components.

Other combinations of baffles in series, whether provided as single discs, pairs of discs, sets of three or more discs, multiple walls, columns as depicted in commonly owned International Application No. PCT/US03/22282; combinations of one or more of baffles and columns and other means for creating turbulent flow are contemplated herein. The use of any of these features operates to create turbulent flow to effectively mix the components as described above. For example, FIGS. 13A and 13B illustrate bottom portion 1104 of cartridges with alternative baffle arrangements. Complementary top portions are not illustrated; however, their design and fabrication is evident in view of FIGS. 11-13. FIG. 13A illustrates an embodiment having baffles 1110 extending from opposite sides of the mixing chamber passageway. This arrangement forms an alternating widening and narrowing of the passageway creating changes in velocity of the constituents to produce a turbulent flow, thereby creating effective mixing within the mixing chamber. In the embodiment of FIG. 13B, baffles 1110 extend from opposite walls of the mixing chamber pathway in a staggered configuration. This creates a tortuous or circuitous flow path through the mixing chamber. This flow path also creates turbulence that leads to effective mixing of container constituents within the mixing chamber. As will be appreciated, other baffle arrangements are also possible that create a flow path to induce effective mixing of container constituents.

In use, the cartridge 202 is inserted in the proper position in the head 104. The head 104 is then placed on top of the canisters containing the constituents to be dispensed and mixed. Stems protruding from the top of the canisters, which may be pressurized containers, rest within the inlets 204 of the cartridge 202 enclosed within the head 104. Depression of the cartridge 202, for example by depressing lever 108, results in depression of the tubes extending from the canisters, thereby releasing the pressurized constituents from the canisters into the inlets. Each of the constituents in the canisters travels through the channel 1106 in the cartridge to a mixing point where they then travel together through the mixing chamber. Inside the mixing chamber, the various constituents are effectively mixed depending upon the desired properties before exiting the nozzle. The nozzle, as stated above, may have a valve, for example, a mechanical breakup valve, inserted therein which affects the way in which the mixed product is dispensed from the container, for example, as a stream or a spray.

One particular advantage of the mixing device 100 according to the present invention is the small number of parts. For example, the mixing device only need include the head 104, which secures to the top of the containers, and a cartridge 202 positioned within the head for accepting the constituents of the containers, mixing them and dispensing the mixed product. Various actuation means can be used other than the lever 108 that is depicted in the illustrated embodiment. For example, the head 104 may have a hole in the top to allow direct depression of the cartridge 202 for releasing the contents of the containers. In such an embodiment, the cartridge can be manufactured with a button on the top which would protrude through the top of the head for actuation of the containers. Thus, all that is required for the present invention is the molding of the head 104 and the top 1102 and bottom 1104 of the cartridge. The cartridge can then be assembled either by gluing or in a snap fit or friction fit manner and inserted into the head.

The use of a handle lever or other means on the mixing device 100 for depression of the cartridge are optional. A handle is particularly useful when the canisters 102, when paired together, are too large for gripping with a single hand. When the handle is present, the lever and the thumb trigger present a relatively easy means for depressing the cartridge and releasing the constituents of the containers as described in the embodiment of Attachment A. In yet another exemplary embodiment, the device could include the handle without the lever and have a opening in the top of the head 104 for depression of the cartridge, as described above. With such a configuration, a user could grip the handle and then, with a thumb, actuate the cartridge.

The configuration depicted in the illustrated embodiment of the invention, including the configuration within the mixing head, is particularly useful for when the constituents of the containers are relatively nonviscous and, when combined to form a mixed product, remain nonviscous. For example, when the constituents of the containers are aqueous solutions, this arrangement works particularly well.

One example of a use of the present invention is in a hot ice melt deicer. In such an embodiment, one canister 102 can include an aqueous solution of an acidic material and the other canister can contain an aqueous solution of a basic material. Activation of the containers results in release of the acidic and the basic solutions, which combine within the mixing chamber of the cartridge. As a result of the neutralization reaction which occurs upon mixing of the acidic and basic solutions, heat is generated and therefore the mixed product that is dispensed from the nozzle is released at a temperature above ambient temperature. Further, the reaction may cause salt formation so that, overall, the material released from the nozzle is an aqueous solution of a salt at an elevated temperature. Other chemical combinations, for example the combination of an oxidizing agent and a reducing agent, can also result in the production of heat and release of product at an elevated temperature. Such a combination is particularly useful for deicing applications. For example, the solution could be dispensed onto an automobile windshield when frost is present to melt the frost. Because the containers are valved in such a way that substantially equal amounts of acid and base are released and mixed, the material exiting the device is neither substantially acidic nor basic and, therefore, not corrosive.

Modifications of the present invention to handle different materials is relatively straightforward. For example, for mixing more viscous materials, columns have been found to be useful. Further, the length of the mixing chamber could be increased so that there is a longer area for mixing of components. In applications having relatively nonviscous components, the mixing chamber as depicted in the embodiment shown in the figures is generally sufficient. In other embodiments, the substances may mix adequately even in the absence of baffles or columns.

Other configurations of components are also contemplated by the invention and the various components and configurations can be interchanged for a particular use. For example, the collar can be a separate component from the head that holds the cartridge. In such an embodiment, the head would be attachable to the collar, and the head may itself be movable to press on the cartridge and actuate release of the contents of the containers. Further, the head may form the top part of the cartridge. Such configurations would be similar to that disclosed in commonly owned International Application No. PCT/US03/22282. Additional configurations include alternative methods for securing the canisters to the device. For example, a canister holder can surround the canisters. The holder can then attach to the collar. Use of a canister holder does not depend on the collar being integral with the head; it can connect to a separate collar or a collar that is integral with the head. Additionally, various cartridges can be used and interchanged within a particular design.

The invention may also be modified for mixing of other products. For example, some products may not require mixing in a 1:1 ratio, in which case the channels may be differently sized or the pressure expelling the canister contents may be varied or the physical characteristics of the aerosol valves affixed to the canisters may be suitably varied. In other uses, mixing to homogeneity may not be required nor desirable. In such a case, the mixing chamber can be modified to decrease the degree of mixing. One advantage of the invention is that cartridges having different internal configurations, for example different baffle configurations, can be used interchangeably with the same head and lever structure. Thus, various cartridges can be molded with substantially the same exterior configuration, but with different mixing chamber configurations. The cartridges can be conveniently manufactured using the same exterior molds, but different internal molding apparatus, as would be known by persons skilled in the art.

The embodiments illustrated and discussed in this specification are intended only to teach those skilled in the art the best way known to the inventors to make and use the invention. Nothing in this specification should be considered as limiting the scope of the present invention. All examples presented are representative and non-limiting. The above-described embodiments of the invention may be modified or varied, without departing from the invention, as appreciated by those skilled in the art in light of the above teachings. It is therefore to be understood that, within the scope of the claims and their equivalents, the invention may be practiced otherwise than as specifically described.

1. A mixing device comprising,
a head mountable atop a plurality of containers and having an outlet and holding a cartridge;
a cartridge comprising an inlet accepting constituents from each of the plurality of containers, a mixing chamber, and a nozzle for dispensing a mixed product extending from the cartridge through the outlet in the head; and
means for securing the head to the containers.

2. The mixing device of claim 1, wherein the means for securing the head to the containers is integral with the head.

3. The mixing device of claim 1, wherein the means for securing the head to the containers is a separate component that is attachable to the head and the containers.

4. The mixing device of claim 1, further comprising a hole in the head for depression of the cartridge.

5. The mixing device of claim 1, further comprising a trigger for depression the cartridge.

6. The mixing device of claim 5, wherein the trigger comprises a lever.

7. The mixing device of claim 1, wherein the interior walls of each inlet have a conical configuration.

8. The mixing device of claim 1, wherein the mixing chamber comprises columns.

9. The mixing device of claim 1, wherein the mixing chamber comprises baffles.

10. The device of claim 1, wherein the cartridge is interchangeable with a second cartridge having the same general exterior configuration and different internal configuration in the mixing chamber.

11. The device of claim 1, wherein the cartridge comprises a channel from each inlet to the mixing chamber, said channels converging at a confluence.

12. The device of claim 11, wherein the confluence is about equidistant from each inlet.

13. The device of claim 11, wherein the channels from the inlets to the confluence and the mixing chamber from the confluence to the nozzle define a “T”.

14. The mixing device of claim 1, further comprising a valve insert within said outlet.

15. The mixing device of claim 14, wherein said valve insert comprises a mechanical breakup valve.

16. A system for dispensing a mixed product comprising,
a plurality of canisters each containing a constituent;
a head attached to said plurality of canisters, said head having an outlet; and
a cartridge comprising an inlet positioned for accepting constituents from each of the plurality of containers, a mixing chamber, and a nozzle dispensing a mixed product extending from the cartridge through the outlet in the head;
wherein said cartridge can be positioned within said head.

17. A system according to claim 16, wherein said cartridge has an inlet for each of said plurality of canisters.

18. The device of claim 16, wherein the cartridge comprises a channel from each inlet to the mixing chamber, said channels converging at a confluence.

19. The device of claim 16, wherein the confluence is about equidistant from each inlet.

20. The device of claim 16, wherein the channels from the inlets to the confluence and the mixing chamber from the confluence to the nozzle define a “T”.

21. The system of claim 16, wherein said plurality of canisters is two canisters.

22. The system of claim 16, wherein the constituent of each of said canisters is an aqueous solution.

23. The system of claim 22, wherein said aqueous solution comprises at least an acid and a basic solution.

24. The system of claim 16, further comprising a means for securing the canisters together.

25. The system of claim 24, wherein the means for securing the canisters together comprises a structure in the head.

26. The system of claim 25, wherein the structure within the head comprises a collar.

27. The system of claim 24, wherein the means for securing the canisters together comprises a structure separate from the head.

28. The system of claim 27, wherein the means for securing the canisters together comprises a shrink wrap.

29. The system of claim 27, wherein the means for securing the canisters together comprises a collar attachable to the head and the canisters.

30. An apparatus for simultaneously dispensing chemicals from at least two pressurized canisters, the apparatus comprising
a head having a handle and adapted for receiving a cartridge, and further adapted for receiving at least two pressurized canisters;
a lever having a first end pivotally attached to the head, and a second opposite end adjacent the handle portion, the lever further comprising a protruding tab point provided between the two ends of the trigger, the protruding tab disposed so as to exert pressure on the cartridge when the lever is activated by a user pressing down on the second opposite end; and
a cartridge having an internal passageway adapted for communicable connection to at least two pressurized canisters, the internal passageway comprising a mixing chamber, the mixing chamber portion having a first end with a confluence and a second end with a nozzle, and further having at least one mixing baffle disposed between the first and second ends.
